(19) United States
(12) Patent Application Publication
(10) Pub. No.: US 2021/0166476 A1
(43) Pub. Date: Jun. 3, 2021

(54) Automatic 3D Image Reconstruction Process from Real-World 2D Images

(71) Applicant: Alpha AR OÜ, Tallinn (EE)

(72) Inventors: Madis ALESMAA, Tallinn (EE); Rait-Eino LAARMANN, Mulgi vald (EE); Gholamreza ANBARJAFARI, Tartu (EE); Cagri OZCINAR, Tartu (EE)

(73) Assignee: Alpha AR OÜ, Tallinn, Harju maakond (EE)

(21) Appl. No.: 16/991,069

(22) Filed: Aug. 12, 2020

Related U.S. Application Data
(60) Provisional application No. 62/941,902, filed on Nov. 29, 2019.

(51) Int. Cl. G06T 17/20; G06T 15/04; G06T 7/11

(52) U.S. Cl. CPC G06T 17/20; G06T 15/04; G06T 2207/20084; G06T 2207/10024; G06T 7/11

(57) ABSTRACT

The invention relates to a method of converting a two-dimensional (2D) image into a three-dimensional (3D) image using an image conversion system having at least one processor and at least one memory, the method comprising: extracting a 2D RGB (Red, Green, Blue) object image attribute from a 2D object image; uploading the extracted 2D RGB object image attribute to a cloud computing service, wherein developed algorithms are located; calculating a 3D mesh object image attribute based on the uploaded and extracted 2D RGB object image attribute; texturing the estimated 3D mesh object from the calculated 3D mesh object image attribute; and displaying the textured 3D mesh object on a display device.

### PRIORITY

This application claims priority of provisional U.S. application No. 62/941,902, filed on Nov. 29, 2019 the content of which is incorporated herein by reference.

### TECHNICAL FIELD OF INVENTION

The present disclosure relates to a method for processing an image, and more particularly, to a method for automatic three-dimensional (3D) image reconstruction process from real-world two-dimensional (2D) images.

### BACKGROUND OF INVENTION

The 3D reconstruction from real-world 2D images is a challenging topic in computer vision. 3D mesh representation of an object gives the ability to the viewers to look at the 3D object from any point of view. 3D mesh models can be used for many different applications such as entertainment, education, e-commerce, etc. A dense 3D mesh model estimation from a 2D real-world image is necessary for many applications to provide realistic 3D objects. Owing to its capable of modelling shape details, a dense 3D mesh is desirable for many applications since it is lightweight and capable of modelling shape details. The dense 3D mesh is beneficial in various applications. For instance, in the entertainment industry, the dense 3D mesh representation allows the user to control the viewing perspective, which can provide a more immersive and interactive visualization experience. In e-commerce, this interactive experience provides a more realistic shopping experience by visualizing an item with different viewing perspective.

To achieve this, textured 3D geometry information of an item to be displayed is necessary, which can be obtained by capturing an object using large amounts of specialized camera equipment. Even though this can produce a high-quality 3D reconstruction of an item, it is not always feasible to capture an item with an expensive camera setup. Thus, such technology is limited only to professional camera setups.

At the moment there exist multiple commercially available solutions in which all models have been created manually, textured manually and have been manually tuned with special camera setups. Therefore, generating such model can take up to multiple days, depending on its complexity, to be generated. Such models should smoothly be generated with a limited time constrained for being used in AR (Augmented Reality) solutions. Low latency is one of the main requirements for AR applications in order to provide high quality of immersive experience.

### SUMMARY OF THE INVENTION

Now, an improved arrangement has been developed to reduce the above-mentioned problems. As different aspects of the invention, the invention presents a method, a server, a computer program product and a system, which are characterized in what will be presented in the independent claims.

The dependent claims disclose advantageous embodiments of the invention.

The first aspect of the invention comprises a method of converting a two-dimensional (2D) image into a three-dimensional (3D) image using an image conversion system having at least one processor and at least one memory, the method comprising: extracting a 2D RGB (Red, Green, Blue) object image attribute from a 2D object image; uploading the extracted 2D RGB object image attribute to a cloud computing service, wherein developed algorithms may be located;

calculating a 3D mesh object image attribute based on the uploaded and extracted 2D RGB object image attribute; texturing the estimated 3D mesh object from the calculated 3D mesh object image attribute and displaying the textured 3D mesh object on a consumers' display devices.

According to an embodiment, the step of the extracting a 2D RGB object image attribute further includes a segmentation algorithm using a deep neural network. According to an embodiment, the segmentation algorithm can be deployed, such as a Mask R-CNN (convolutional neural network) or other state-of-the-art segmentation algorithms.

According to an embodiment, the segmentation algorithm is performed depending on a segmentation algorithm selection.

According to an embodiment, the step of calculating a 3D mesh object image attribute further includes determining the calculated 3D mesh object image attribute, wherein the calculated 3D mesh object image attribute is compared with a predetermined threshold value to determine whether the comparison result value is greater than the predetermined threshold value.

According to an embodiment, the step of the texturing estimated 3D mesh object further includes detecting different parts of the 2D object image and mapping the detected different parts the 2D object image on a corresponding region in the textured 3D mesh object.

According to an embodiment, the display is touchable and the system is capable of receiving and using feedback from consumers to improve a 3D reconstruction quality.

A second aspect of the invention includes a server arranged to receive information about a extracted a 2D RGB object image attribute from a 2D object image; upload the extracted 2D RGB object image attribute to a cloud computing service, wherein developed algorithms may located; calculate a 3D mesh object image attribute based on the uploaded and extracted 2D RGB object image attribute; texture the estimated 3D mesh object from the calculated 3D mesh object image attribute; and a display configured to display the textured 3D mesh object. In addition to automatic object detection, the consumers have options to manually select an object using the bounding box, and the selected object can be extracted for generating 3D mesh object.

According to an embodiment, the server is arranged to perform the method of any of the embodiments above.

A third aspect of the invention includes a computer program product for converting a two-dimensional (2D) image into a three-dimensional (3D) image, where the computer program product comprises a non-transitory computer readable media encoded with a computer program which is executable in a processor, and when the computer program is executed in the processor, it is configured to perform the steps of: extracting a 2D RGB object image attribute from a 2D object image; uploading the extracted 2D RGB object image attribute to a cloud computing service, wherein developed algorithms may be located; calculating a 3D mesh object image attribute based on the uploaded and extracted 2D RGB object image attribute; texturing the estimated 3D mesh object from the calculated 3D mesh object image attribute; and displaying the textured 3D mesh object on a display device.

According to an embodiment, the server is arranged to perform the method of any of the embodiments above.

A fourth aspect of the invention includes a system arranged to convert a two-dimensional (2D) image into a three-dimensional (3D) image using an image conversion system having at least one processor and at least one memory, the system comprising: a sensor configured to extract a 2D RGB object image attribute from a 2D object image; a controller configured to upload the extracted 2D RGB object image attribute to a cloud computing service, wherein developed algorithms may be located; calculate a 3D mesh object image attribute based on the uploaded and extracted 2D RGB object image attribute; and texture the estimated 3D mesh object from the calculated 3D mesh object image attribute; and a display configured to display the textured 3D mesh object. The consumers can provide a feedback (such as bad, average, good, excellent) for the quality of the textured 3D mesh object generated by this invention, and after collecting the defined number of feedback scores, the developed neural network can be finetuned, resulting better 3D reconstruction quality in future tasks.

According to an embodiment, the system is arranged to perform the method of any of the embodiments above.

### BRIEF DESCRIPTION OF THE DRAWINGS

Next the invention will be described in greater detail with reference to exemplary embodiments in accordance with the accompanying drawings, in which:

FIG. 1 illustrates a schematic diagram of the developed system with a cloud computing service according to one embodiment of the invention;

FIG. 2 is a flowchart of a method for converting a two-dimensional (2D) image into a three-dimensional (3D) image using an image conversion system according to an embodiment;

FIG. 3 is a flowchart of a method of converting a two-dimensional (2D) image into a three-dimensional (3D) image using an image conversion system through a segmentation algorithm according to an embodiment; and

FIG. 4 is a flowchart of a method for converting a two-dimensional (2D) image into a three-dimensional (3D) image using an image conversion system through updating a parameter of a segmentation algorithm according to an embodiment.

### DESCRIPTION OF THE INVENTION

Description will now be given in detail of preferred configurations of mobile terminals according to the present invention, with reference to the accompanying drawings. Hereinafter, suffixes “module” and “unit or portion” for components used herein in description are merely provided only for facilitation of preparing this specification, and thus they are not granted a specific meaning or function. Hence, it should be noticed that “module” and “unit or portion” can be used together.

In describing the present invention, if a detailed explanation for a related known function or construction is considered to unnecessarily divert from the gist of the present invention, such explanation has been omitted but would be understood by those skilled in the art. The accompanying drawings are used to help easily understood the technical idea of the present invention and it should be understood that the idea of the present invention is not limited by the accompanying drawings. This invention describes an automatic image to a 3D object (3D mesh representation) conversion approach to generate realistic 3D models. Generating a realistic look of a 3D model from a 2D input image using fine-tuned deep neural networks which will be used in the visualization of 3D objects in AR devices for e-commerce purposes, and other similar or related solutions of AR. For this purpose, this invention proposes a framework to be used for the 3D reconstruction task. The algorithm benefits from deep neural networks to estimate a dense 3D model from a given 2D real-world image and apply the texture of a given 2D real-world image to the 3D model generated by the deep neural network algorithm.

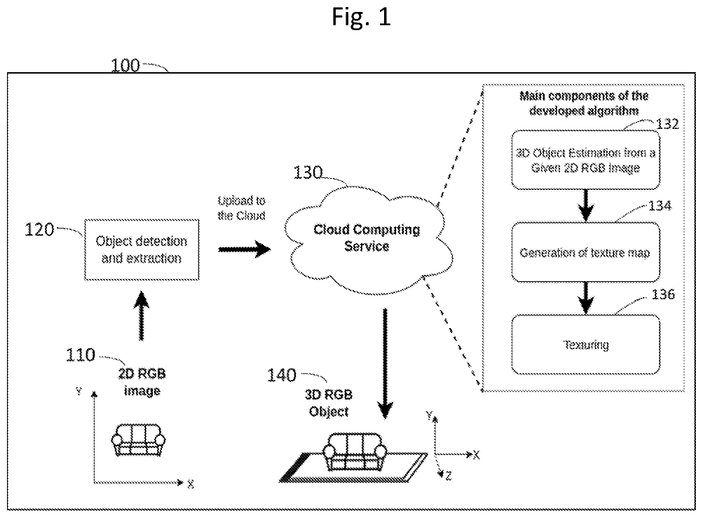

FIG. 1 illustrates a schematic diagram of the developed system with a cloud computing service. As illustrated in FIG. 1, system 100 may comprise object detection and object extracting unit 120 and the cloud computing service unit 130. As a first step, in extracting unit 120, an object 110 may be detected in a given RGB (Red, Green, Blue) image, and extracted from the background scene. Here, the state-of-the-art 2D object detection and segmentation algorithm, Mask R-CNN or other similar algorithms, may be utilized to generate a segmentation mask for an object in the image. This mask may be then used to extract the object from its background scene.

The extracted 2D RGB object image may be then uploaded on the cloud computing service unit 130, wherein the developed algorithms may be located. The cloud computing service unit 130 may include 3D objection estimation module 132, generation of texture module 134 and texturing module 136. In the 3D objection estimation module 132 and generation of texture module 134, the image to 3D mesh algorithm developed in within this invention estimates a 3D mesh object from a given 2D RGB image. In texturing module 136, this estimated 3D mesh object may be then textured using the developed texturing algorithms. As a final step, the textured 3D objects 140 may be visualized using various devices, e.g., mobile phones, tablets, PC, etc., for augmented reality applications.

In the following, the main components of the developed invention are described:

a) 2D Image to 3D Object

This invention may use graph theory to model a 3D object from the input 2D image. The model used in this task requires the integration of two modalities: 3D Geometry and 2D image. On the 3D geometry side, the algorithm builds a graph using a graph convolutional network (GCN) on the mesh model, where the mesh vertices and edges are defined as nodes and connections in a graph, respectively. A graph consists of vertices and edges, (V, E), where V={v₁, v₂ . . . v_{N}} is the set of N vertices in the mesh, and E={e₁, e₂ . . . e_{N}} is the set of E edges. In this model, encoding information for 3D shape is saved per vertex and the convolutional layers of the GCN enable feature exchanging across neighboring nodes and predict the 3D location for each vertex.

On the 2D image side, 2D convolutional neural network (CNN) and Visual Geometry Group (VGG)-16 like architecture, may be used to extract perceptual features from the input image. These extracted features may be then leveraged by the GCN to progressively deform a given ellipsoid mesh into the desired 3D model. Formally, GCN takes an input feature matrix, N×F, where N is the number of nodes and L is the number of features which are attached on vertices, F={f₁, f₂ . . . f_{N}} where F consist of feature vectors attached on vertices. The proposed network learns to gradually deform and increase shape details in a coarse-to-fine fashion. In the graph unpooling layers increase the number of vertices to increase the capacity of handling details.

The shape details of the 3D model may be refined with the help of adversarial learning, and training using diverse set of data set. The network has been trained based on ShapeNet database, Pix3D dataset, and over thousands of samples gathered by Intelligent Computer Vision (iCV) Lab, which contains real-world images featuring diverse objects and scenes.

To constrain the property of the output shape and the deformation procedure, the present invention may define four different differentiable loss functions. In the proposed network, the Chamfer distance loss and normal loss, Earth-mover

Distance, and Laplacian regularization loss may be utilized to guarantee perceptually appealing results. Here, the Chamfer and normal losses penalize mismatched positions and normals between triangular meshes.

b) Texturing

After 3D modelling, the present invention may be conducting texturing locally by detecting different parts of the 2D image and mapping them on the corresponding region in the 3D model. Different parts of the object may be being detected with our fine-tuned DarkNet model or similar model for polygonal meshes, generating multiple texture patches. The present invention may generate texture atlases to map a given 2D texture onto the 3D model generated in the previous section. Here, each face is projected onto its associated texture image to get projection region. For each patch, the different tuned model has been adopted so that the mapping process will be as automatic as possible. Then, the algorithm adds plausible and consistent shading effects on the 3D textured model.

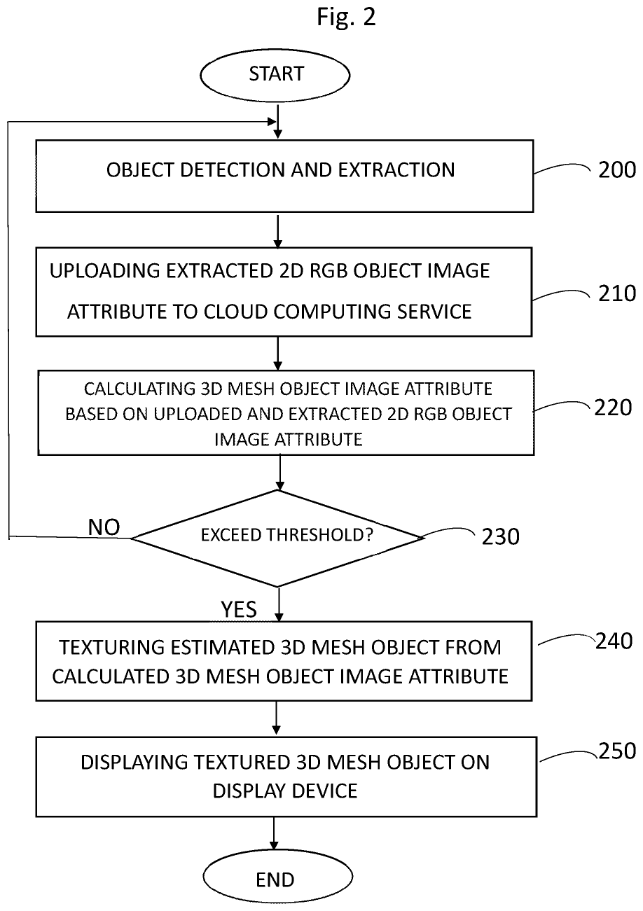

FIG. 2 is a flowchart of a method for converting a two-dimensional (2D) image into a three-dimensional (3D) image using an image conversion system. The method comprises extracting a 2D RGB object image attribute from a 2D object image 200; uploading the extracted 2D RGB object image attribute to a cloud computing service, wherein developed algorithms may be located 210; calculating a 3D mesh object image attribute based on the uploaded and extracted 2D RGB object image attribute 220; determining the calculated 3D mesh object image attribute 230, wherein the calculated a 3D mesh object image attribute result value, which has been obtained at the calculation step 220, may be compared with a predetermined threshold value to determine whether the comparison result value is greater than the predetermined threshold value; texturing the estimated 3D mesh object from the calculated 3D mesh object image attribute 240; and displaying the textured 3D mesh object on a display device 250. The threshold value may be estimated with a no-reference quality metric developed for 3D mesh.

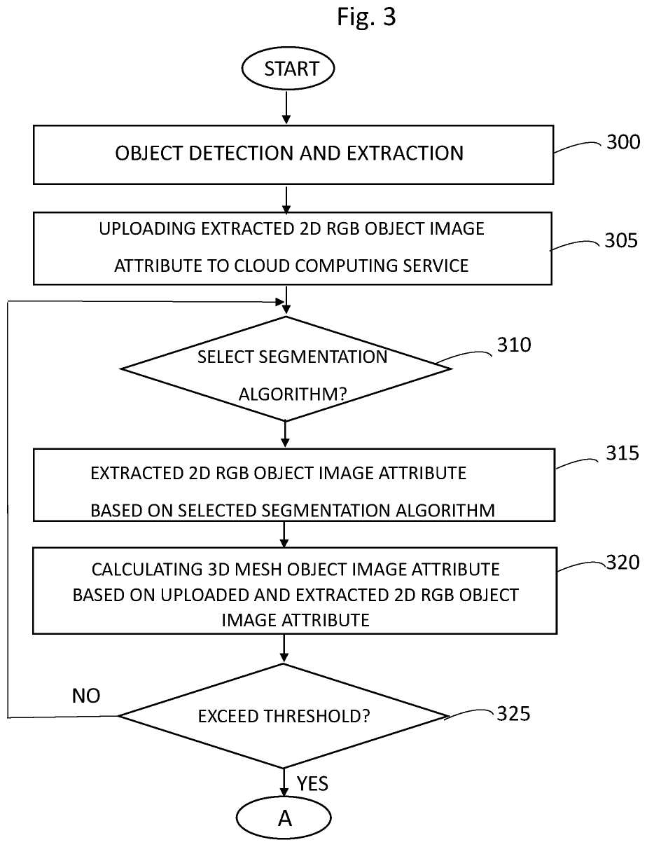

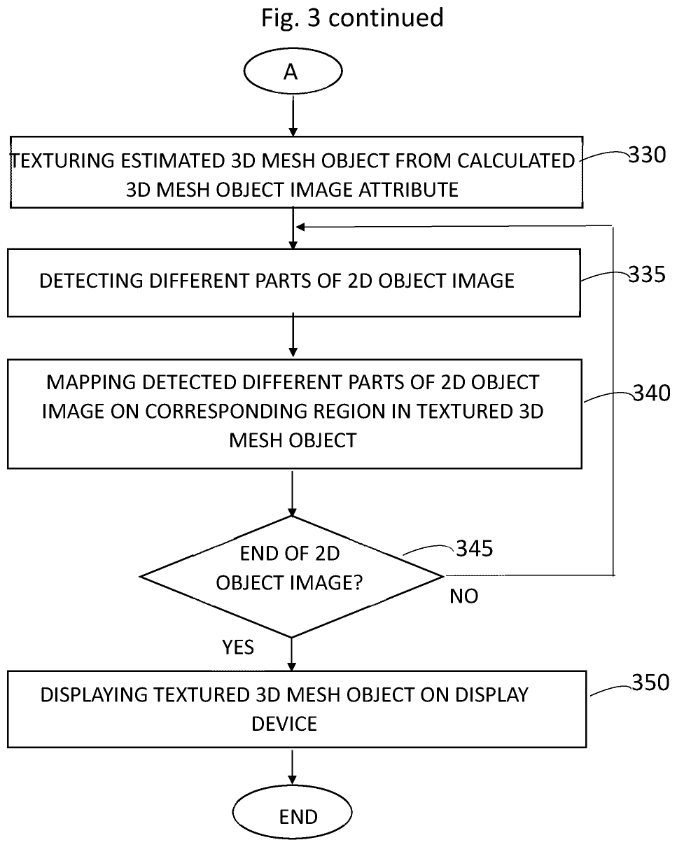

FIG. 3 is a flowchart of a method for converting a two-dimensional (2D) image into a three-dimensional (3D) image using an image conversion system through a segmentation algorithm. The method comprises extracting a 2D RGB object image attribute from a 2D object image 300; uploading the extracted 2D RGB object image attribute to a cloud computing service, wherein developed algorithms may be located 305; selecting segmentation algorithm, wherein the segmentation algorithms may be a deep neural network such as convolutional neural network and the segmentation algorithms may be a Mask R-CNN (convolutional neural network) 310; extracting 2D RGB object image attribute based on the selected segmentation algorithm 315; calculating a 3D mesh object image attribute based on the uploaded and extracted 2D RGB object image attribute 320; determining the calculated 3D mesh object image attribute, wherein the calculated a 3D mesh object image attribute result value, which has been obtained at the calculation step 320, may be compared with a predetermined threshold value to determine whether the comparison result value is greater than the predetermined threshold value 325; texturing the estimated 3D mesh object from the calculated 3D mesh object image attribute 330; detect the different part of 2D object image 335; mapping the detected different parts of 2D object image on a corresponding region in the textured 3D mesh object 340; check the end of 2D image 345; and displaying the textured 3D mesh object on a display device 350.

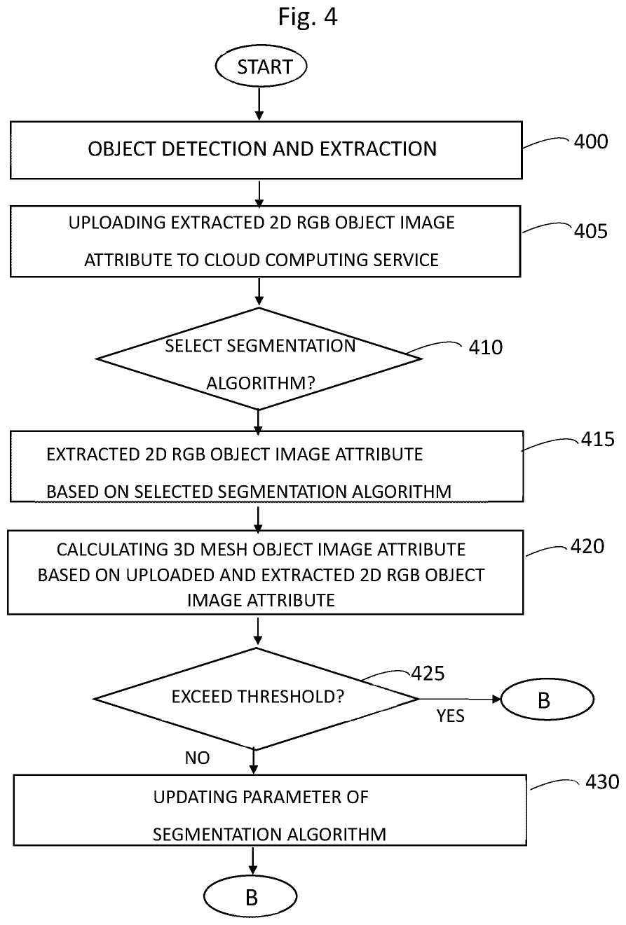

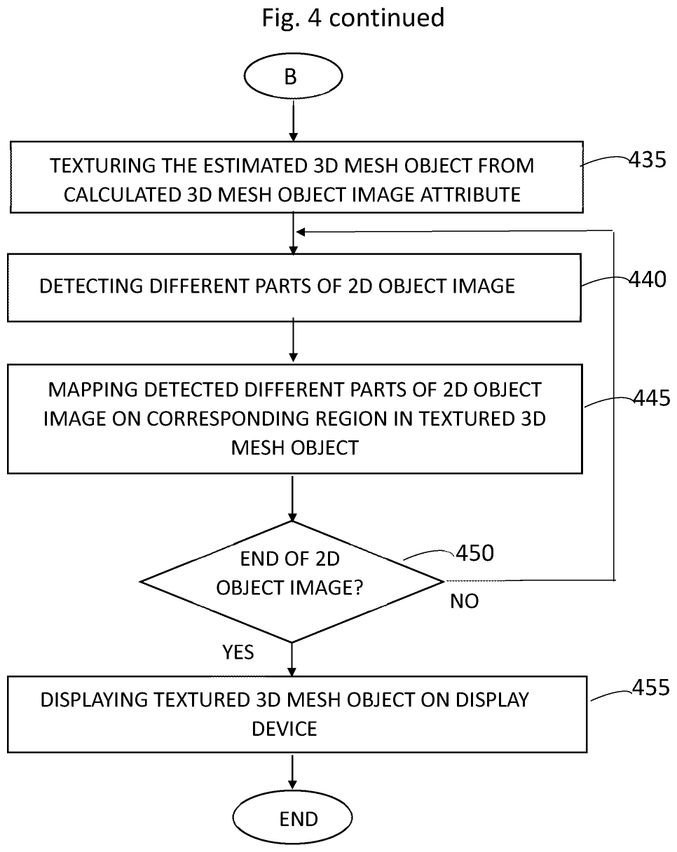

FIG. 4 is a flowchart of a method for converting a two-dimensional (2D) image into a three-dimensional (3D) image using an image conversion system through updating a parameter of a segmentation algorithm. The method comprises extracting a 2D RGB object image attribute from a 2D object image 400; uploading the extracted 2D RGB object image attribute to a cloud computing service, wherein developed algorithms may be located 405; selecting segmentation algorithm, wherein the segmentation algorithms may be a deep neural network such as convolutional neural network and the segmentation algorithms may be a Mask R-CNN (convolutional neural network) 410; extracting 2D RGB object image attribute based on the selected segmentation algorithm 415; calculating a 3D mesh object image attribute based on the uploaded and extracted 2D RGB object image attribute 420; determining the calculated 3D mesh object image attribute, wherein the calculated a 3D mesh object image attribute result value, which has been obtained at the calculation step 420, may be compared with a predetermined threshold value to determine whether the comparison result value is greater than the predetermined threshold value 425; if the calculated 3D mesh object image attribute is lower than a predetermined threshold value, updating parameters of segmentation algorithm 430, wherein the parameters comprise convolution size, stride, padding, maximum pooling size, stride, padding, dropout, up sampling size, optimizer, learning rate, loss function, number of filters for convolutional layer, layer (weight) initialization, cropping size per edge, image size, initial learning rate, number of epochs, etc; if the calculated 3D mesh object image attribute is greater than a predetermined threshold value, texturing the estimated 3D mesh object from the calculated 3D mesh object image attribute 435; detect the different part of 2D object image 440; mapping the detected different parts of 2D object image on a corresponding region in the textured 3D mesh object 445; check the end of 2D image 450; and displaying the textured 3D mesh object on a display device 455.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard, it should be noted that any blocks of the logic flow as in the Figures may represent program steps, or interconnected logic circuits, blocks and functions, or a combination of program steps and logic circuits, blocks and functions. The software may be stored on such non-transitory physical media as memory chips, or memory blocks implemented within the processor, magnetic media such as hard disks or floppy disks, and optical media such as DVD and the data variants thereof, CD.

A person skilled in the art appreciates that any of the embodiments described above may be implemented as a combination with one or more of the other embodiments, unless it is explicitly or implicitly stated that certain embodiments are only alternatives to each other.

It is obvious to a person skilled in the art that with technological developments, the basic idea of the invention can be implemented in a variety of ways. Thus, the invention and its embodiments are not limited to the above-described examples, but they may vary within the scope of the claims.

What is claimed is:

1. A method of converting a two-dimensional (2D) image into a three-dimensional (3D) image using an image conversion system having at least one processor and at least one memory, the method comprising:
extracting a 2D RGB (Red, Green, Blue) object image attribute from a 2D object image;
uploading the extracted 2D RGB object image attribute to a cloud computing system, wherein developed algorithms are located;
calculating a 3D mesh object image attribute based on the uploaded and extracted 2D RGB object image attribute;
texturing the estimated 3D mesh object from the calculated 3D mesh object image attribute; and
displaying the textured 3D mesh object on a display device.

2. The method according to claim 1, wherein the step of the extracting a 2D RGB object image attribute further includes a segmentation algorithm using a deep neural network.

3. The method according to claim 2, wherein the segmentation algorithm is a Mask R-CNN (convolutional neural network).

4. The method according to claim 2, wherein the segmentation algorithm is performed depending on a segmentation algorithm selection.

5. The method according to claim 1, wherein the step of calculating a 3D mesh object image attribute further includes determining the calculated 3D mesh object image attribute, wherein the calculated 3D mesh object image attribute is compared with a predetermined threshold value to determine whether the comparison result value is greater than the predetermined threshold value.

6. The method according to claim 1, wherein the step of calculating a 3D mesh object image attribute further includes detecting different parts of the 2D object image and mapping the detecting different parts the 2D object image on a corresponding region in the textured 3D mesh object.

7. The method according to claim 1, wherein the display is touchable and the system is capable of receiving and using feedback from consumers to improve a 3D reconstruction quality.

8. A server arranged to
receive information about a extracted a 2D RGB object image attribute from a 2D object image;
upload the extracted 2D RGB object image attribute to a cloud computing service, wherein developed algorithms are located;
calculate a 3D mesh object image attribute based on the uploaded and extracted 2D RGB object image attribute;
texture the estimated 3D mesh object from the calculated 3D mesh object image attribute; and
a display configured to display the textured 3D mesh object.

9. A non-transitory computer program product for converting a two-dimensional (2D) image into a three-dimensional (3D) image, where the computer program product comprises a non-transitory computer readable media encoded with a computer program which is executable in a processor, and when the computer program is executed in the processor, it is configured to perform the steps of:
extracting a 2D RGB object image attribute from a 2D object image;
uploading the extracted 2D RGB object image attribute to a cloud computing service, wherein developed algorithms are located;
calculating a 3D mesh object image attribute based on the uploaded and extracted 2D RGB object image attribute;
texturing the estimated 3D mesh object from the calculated 3D mesh object image attribute; and
displaying the textured 3D mesh object on a display device.

10. A system arranged to convert a two-dimensional (2D) image into a three-dimensional (3D) image using an image conversion system having at least one processor and at least one memory, the system comprising:
an extractor configured to extract a 2D RGB object image attribute from a 2D object image;
a controller configured to upload the extracted 2D RGB object image attribute to a cloud computing service, wherein developed algorithms are located, calculate a 3D mesh object image attribute based on the uploaded and extracted 2D RGB object image attribute, and texture the estimated 3D mesh object from the calculated 3D mesh object image attribute; and
a display configured to display the textured 3D mesh object.

11. The system according to claim 10, wherein the extractor configured to extract a 2D RGB object image attribute further includes a segmentation algorithm using a deep neural network.

12. The system according to claim 11, wherein the segmentation algorithm is a Mask R-CNN (convolutional neural network).

13. The system according to claim 11, wherein the segmentation algorithm is performed depending on a segmentation algorithm selection.

14. The system according to claim 10, wherein the controller configured to calculate a 3D mesh object image attribute further includes determining the calculated 3D mesh object image attribute, wherein the calculated 3D mesh object image attribute is compared with a predetermined threshold value to determine whether the comparison result value is greater than the predetermined threshold value.

15. The system according to claim 10, wherein the controller configured to texture estimated 3D mesh object further includes detecting different parts of the 2D object image and mapping the detecting different parts the 2D object image on a corresponding region in the textured 3D mesh object.

16. The system according to claim 10, wherein the display is touchable and the system is capable of receiving and using feedback from consumers to improve a 3D reconstruction quality.
